(19) United States
(12) Patent Application Publication
(10) Pub. No.: US 2005/0131942 A1
(43) Pub. Date: Jun. 16, 2005

(54) Assisted generating system and method for layout data conversions

(76) Inventors: Wei-Fan Ting, Taipei (TW); Shu-Yun Chen, Taipei (TW); Fu-Chung Wu, Taipei (TW); Chung-Hua Chiao, Taipei (TW); Kuang-Yu Peng, Taipei (TW)

Correspondence Address: BIRCH STEWART KOLASCH & BIRCH, PO BOX 747, FALLS CHURCH, VA, 22040-0747, US

(21) Appl. No.: 10/734,176

(22) Filed: Dec. 15, 2003

(51) Int. Cl. G06F 17/00

(52) U.S. Cl. 707/104.1

(57) ABSTRACT

An assisted generating system and method for layout data conversions converts an output file generated by a circuit design program (such as ConceptHDL). In addition to rule setting, the method automatically adjusts fields with abnormal properties. It provides a user interface with hints for the user to edit the contents. The system finally outputs a converted file compatible with a circuit layout program (such as Allegro) to assist subsequent layout designs.

### BACKGROUND OF THE INVENTION

1. Field of Invention

The invention relates to a data processing system and method. More particularly, the invention relates to a system and method that, during a layout process, converts and adjusts layout data generated by other programs and output a result to assist other programs for actual layout designs.

2. Related Art

Normal layout processes involve two stages (see FIG. 1). The first stage is the circuit design. A circuit design engineer uses a circuit design program 10 (such as ConceptHDL) to manually set the attributes of each circuit in this stage. Afterwards, the circuit design program 10 generates a corresponding output file 20. A circuit layout program 30 (such as Allegro) reads in the output file 20 and enters the circuit layout stage. In this stage, the circuit design engineer has to perform rule setting processes for each circuit. After all this is done, the circuit layout program 30 can generate a final circuit diagram.

Although the above-mentioned layout process has used individual professional programs to assist circuit layout designs, there are still the following problems:
(1) There is no integration mechanism for existing programs. Since these professional programs can only provide simple operational mechanisms, the circuit design engineers have to manually perform the settings in the layout process. As these programs are not fully integrated, the engineers have to familiarize themselves with different program operation interfaces and repeat same settings in different programs. This inevitably results in waste in manpower and time.
(2) There is no checking mechanism in existing programs. Since these professional programs cannot automatically check the contents set by the circuit design engineer, he or she has to spend extra time to check the circuit settings during different stages of the layout process. When an error is found, the engineer has to go back to the previous stage to do the settings again. This is particularly inefficient when many errors occur in a complicated circuit design.

Therefore, it will be extremely helpful if the layout data generated by different professional programs can be effectively integrated and automatically check. It is also helpful if one can provide a common, friendly user interface for the engineer to perform layout setting and checking. It is believed that this can greatly simplify the layout process and reduce chances of errors.

### SUMMARY OF THE INVENTION

The invention provides an assisted generating system and method for lyout data conversions. With reference to FIG. 2, a primary technical means of the invention is to use an application programming interface (API) provided by the disclosed convernsion module 43 to convert an output file 20 generated by an existing circuit design program 10 (such as ConceptHDL). Rules predetermined in a property database 41 are employed to set various fields. Properties predetermined in a rule database 42 are employed to adjust the properties of abnormal fields. Finally, it produces a converted file that can be processed by a circuit layout program 30 (such as Allegro) for actual layout designs.

The invention further provides a user interface (UI) 44 that is compatible with a spread sheet program (such as EXCEL). This enables the circuit design engineer to check all circuit settings (including property settings and rule settings) immediately. It also provides an editing function for the enginner to make immediate adjustments.

To achieve the above-mentioned goals, the disclosed system uses a data conversion assisted generating system 40 to produce the layout data. It contains the following modules: a property database 41, a rule database 42, a conversion module 43, and a UI 44.

The disclosed assisted generating method for layout data conversions includes the following steps. First, an output file is obtained for analysis. The system then performs the conversion of more than one field. The system adjusts properties, sets rules, and displays them in the UI. Finally, a converted file is output for actual layout designs.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the conventional layout processing;

FIG. 2 is a schematic view of the disclosed assisted generating system and method for layout data conversions;

FIG. 3 shows the main procedure of the invention; and

FIG. 4 shows an adjustment procedure of the invention.

### DETAILED DESCRIPTION OF THE INVENTION

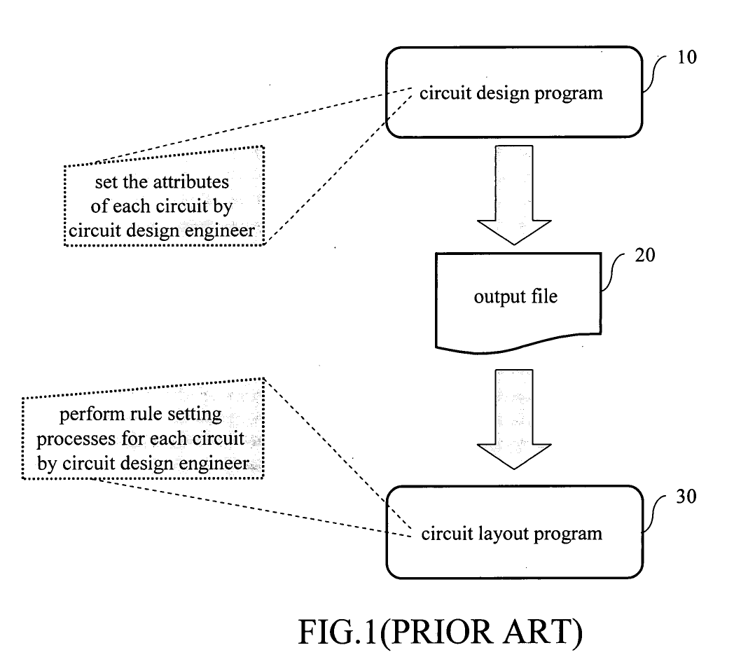

As described before, a conventional layout process is shown in FIG. 1. The circuit design enginner has to use a circuit design program 10 (such as ConceptHDL) to manually set the properties of a circuit in the circuit design stage. Once the circuit design program 10 produces an output file 20 to a circuit layout program 30, the engineer then manually set rules in the circuit. This indeed renders more errors and a low efficinecy in the layout process.

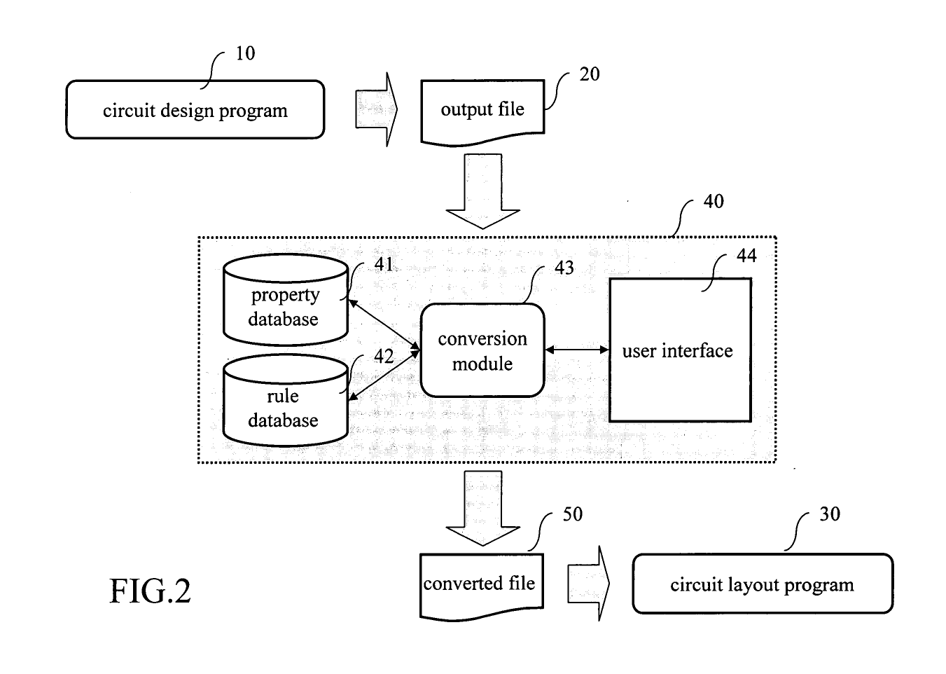

The invention provides an assisted generating system and method for layout data conversions. With reference to FIG. 2, an assisted generating system for data conversions 40 is used to convert and generate layout data. The system 40 includes at least the following modules:
(1) A property database 41. It stores the definitions of properties for more than one field. Since each circuit layout contains different property definitions, the disclosed property database 41 uses a unified set of names to define all circuits. The properties of each kind of circuit are defined explicitly. Therefore, as long as the circuit design by the engineer follows the unified set of names defined therein, the associated property definitions for each circuit can be readily found from the property database 41.
(2) A rule database 42. It stores the defintions of rules for more than one field. Since each layout circuit contains a different set of rule definitions, the disclosed rule database also unifies the names of all circuits, defining the rules that each named circuit has. Therefore, as long as the circuit designed by the engineer follows the unified set of names, the associated rule definitions can be readily found from the rule database 42 and filled into the corresponding fields once the output file 20 generated by the circuit design program 10 is obtained.

The above-mentioned property database 41 and the rule database 42 have to satisfy the same naming rules. The naming rules can be defined by the user. Once the names are defined, the properties and rules of individual fileds in the layout data can be identified for checking and setting.
(3) A conversion module 43. It is used to analyze the output file 20 generated by the circuit design program 10 to generate more than one field. The analysis employs an API to perform format conversions. The converted fields, property database 41, and rule database 42 satisfy the same naming rules.

Once the format conversion is completed, the conversion module 43 extracts the rule definitions of each field from the rule database 42 to perform settings. It also automatically adjusts the property definitions of individual fields. Finally, a converted file 50 is produced.

The part of adjusting the property definitions of individual fields mainly determines whether the property settings in each field are normal. If they are abnormal, the system automatically extracts the appropriate property definitions from the property database 41 and fills them into the field to ensure the integrity of the circuit settings. Besides setting adjustments, the convension module 43 furhter highlights the adjusted fields so that the engineer can immediately see whether he or she needs to manually make adjustments. This also ensures the correctness of the layout data.
(4) A user interface (UI) 44. It is sued to display the contents of the layout data converted by the conversion module 43. The contents include various fields and the associated property definitions and rule definitions. In order for the circuit design engineer to perform manual adjustments and settings, the UI 44 further contains a complete set of editing commands so that the engineer can use an input device (such as a keyboard) for editing.

In a preferred embodiment of the invention, the UI 44 has an interface compatible with other spread sheet programs (such as EXCEL) for the convenience of editing and browsing.

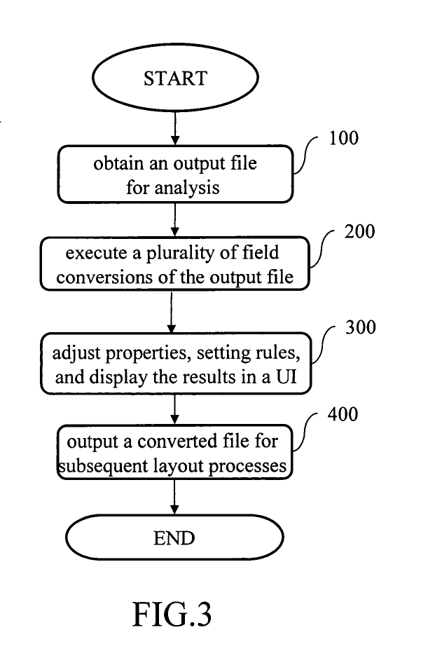

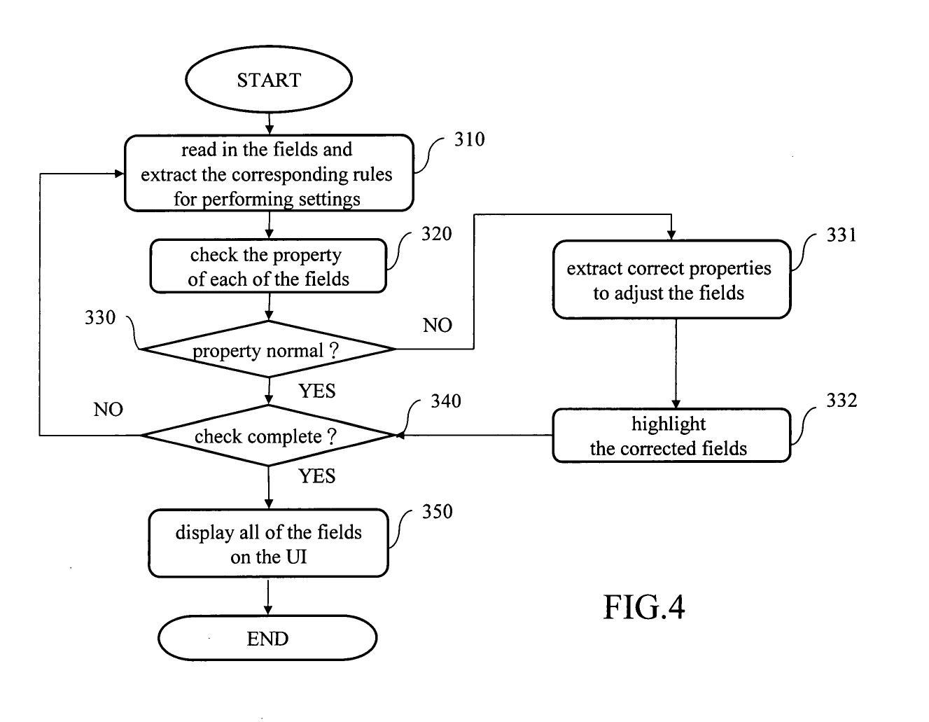

FIG. 3 shows the main flowchart of the invention. We explain its details with simultaneous reference to FIG. 2. First, the data conversion assisted generating system 40 obtains an output file 20 generated by the circuit design program 10 (step 100). The analysis is performed using the API provided by the convernsion module 43. Each field in the output file 20 is converted (step 200) so that the layout data in the format specific to the circuit design program 10 are changed into ones that can be processed by the data conversion assisted generating system 40. That is, the contents in the output file 20 are converted using a definite set of naming rules. The ssystem then adjusts properties, sets rules, and displays the results on the UI (step 300). This step is mainly used to deal with abnormal fields. The details will be explained with reference to FIG. 4. Finally, the adjusted layout data are converted into a converted file 50 that can be processed by the circuit layout program 30 (step 400) for subsequent layout processes.

When entering step 300, the data conversion assisted generating system 40 performs automatic adjustments to the layout data. First, each field is read into the system (step 310). The rule definition of each field is extracted from the rule database 42 for performing settings. Steps 320 through 340 are executed for each of the fields, adjusting the property definitions of all fields. Step 320 checks the field being read in. Step 330 determines whether a particular field is abnormal (such as no data, incorrect data, etc). If there is no error or the abnormal field is corrected, the system enters step 340 to check if there is any other field to be checked. If there is, steps 320 through 340 are repeated.

When step 330 discovers an abnormal field, the conversion module 43 extract the appropriate property definition from the property database 41 to correct the field (step 331). All the corrected fields are highlighted by the conversion module (step 332). The purpose is to allow the circuit design engineer to quickly confirm the correctness of the layout data while browsing on the UI 44. Once all adjustments are done, the system returns to step 340.

After all layout data are checked (step 340), the conversion module shows the results of all fields on the UI 44 (step 350) and then enters step 400. In addition to browsing, the UI 44 also provides editing commands for the engineer to edit the fields, property definitions, and rule definitions using an input device (such as a keyboard). In a preferred embodiment of the invention, the UI 44 provides an interface compatible with a spread sheet program. Thus, the engineer can conveniently browse and maintain the properties and rules of the layout data. Nonetheless, the UI 44 can be designed according to practical needs and is not limited by the disclosed embodiments herein.

After step 400, the converted file 50 produced by the invention is transmitted to the circuit layout program 30 for subsequent layout processes.

Certain variations would be apparent to those skilled in the art, which variations are considered within the spirit and scope of the claimed invention.

1. An assisted generating system for layout data conversions to convert layout data in an output file from a circuit design program (such as ConceptHDL) into a converted file to help actual layout designs of a circuit layout program (such as Allegro), which system comprises:
a property database, which stores property definitions of a plurality of fields;
a rule database, which stores rule definitions of a plurality of fields;
a conversion module, which analyzes contents of the output file to generate a plurality of fields, extracts the corresponding rule definitions for performing settings, and adjusts property definitions of all of the fields to produce a converted file; and
a user interface (UI), which displays all of the fields along with the corresponding property definitions and rule definitions.

2. The system of claim 1, wherein the conversion module further highlights the adjusted fields.

3. The system of claim 1, wherein the UI further provide editing commands for the user to edit the displayed fields, property definitions, and rule definitions.

4. The system of claim 1, wherein the UI uses an interface compatible with a spread sheet program.

5. An assisted generating method for layout data conversions to convert layout data in an output file from a circuit design program (such as ConceptHDL) into a converted file to help actual layout designs of a circuit layout program (such as Allegro), which method comprises the steps of:
obtaining the output file for analysis;
executing a plurality of field conversions of the output file;
adjusting properties, setting rules, and displaying the results in a user interface (UI); and
outputting a converted file for subsequent layout processes.

6. The method of claim 5, wherein the UI uses an interface compatible with a spread sheet program.

7. The method of claim 5, wherein the step of adjusting properties, setting rules, and displaying the results in a UI further comprises the steps of:
reading in the fields and extracting the corresponding rules for performing settings;
checking whether the property of each of the fields is abnormal; and
displaying all of the fields on the UI after they are checked.

8. The method of claim 8, wherein the step of checking whether the property of each of the fields is abnormal comprises the steps of:
extracting correct properties to adjust the fields; and
highlighting the corrected fields.
